(19) United States
(12) Patent Application Publication
(10) Pub. No.: US 2025/0381539 A1
(43) Pub. Date: Dec. 18, 2025

(54) MIXING TANK AND MIXING DEVICE

(71) Applicant: TOYOTA JIDOSHA KABUSHIKI KAISHA, Aichi-ken (JP)

(72) Inventors: Hirokazu TAKEUCHI, Toyota-shi (JP); Shinji KOJIMA, Nagoya-shi (JP); Takahiko NAKANO, Nagoya-shi (JP); Yusuke KINTSU, Miyoshi-shi (JP); Takeshi KONDO, Kariya-shi (JP); Keigo OYAIZU, Kariya-shi (JP)

(21) Appl. No.: 19/215,261

(22) Filed: May 21, 2025

(30) Foreign Application Priority Data
Jun. 13, 2024 (JP) 2024-096220

(51) Int. Cl. B01F 35/512; B01F 23/60; B01F 27/1125; B01F 27/95

(52) U.S. Cl. CPC B01F 35/512; B01F 27/1125; B01F 27/95; B01F 23/60

(57) ABSTRACT

In a mixing tank, an upper part of an inner wall in a height direction has a higher surface roughness than a lower part thereof.

### CROSS-REFERENCE TO RELATED APPLICATION

This application is based on and claims priority under 35 USC 119 from Japanese Patent Application No. 2024-096220 filed on Jun. 13, 2024, the disclosure of which is incorporated by reference herein.

### BACKGROUND

### Technical Field

The present disclosure relates to a mixing tank and a mixing device.

### Related Art

In processes to manufacture a secondary battery, such as a lithium-ion secondary battery or the like, a negative electrode paste containing a negative electrode active substance and a positive electrode paste containing a positive electrode active substance are prepared, and a negative electrode and a positive electrode are produced by coating a negative electrode current collector foil and a positive electrode current collector foil or the like with the respective pastes. Japanese Patent Application Laid-Open (JP-A) No. 2010-257653 describes a method to produce a paste by mixing an active substance and a dispersant together to produce a powder mixture, and then kneading the powder mixture while adding water as a dispersion medium thereto (rough kneading process, thick paste process). JP-A No. 2010-257653 discloses technology that enables the quality of the paste to be controlled by determining an optimum amount of the dispersion medium to be added, an optimum time for the thick paste process, and the like as manufacturing conditions in the thick paste process for paste manufacture.

Moreover, JP-A No. 2008-100197 discloses, as a mixing device for mixing various raw materials, a mixing device that is able to easily clean off raw material adhered to a mixing tank and/or stirring blade in mechanical stirrer style high-speed flow type mixer having a vertical rotation shaft, and discloses a method to simply and reliably discharge left-over raw material remaining after raw material has been discharged. JP-A No. 2008-100197 discloses forming a coating layer on an inside surface of a mixing tank and/or a surface of a stirring blade to improve release of raw material therefrom. The technology of JP-A No. 2008-100197 enables adhered raw material to be easily discharged by providing the coating layer.

Furthermore, JP-A No. H7-328407 discloses a disperser that disperses a pigment in a liquid, as a disperser equipped with a fountain device disposed at the inside of a lidded mixing tank and spraying the liquid upward such that the liquid is sprayed against the inner face of the lid. The technology of JP-A No. H7-328407 is able to prevent pigment or the like from remaining adhered to the inner face of the lid and the actual contained amount of the pigment etc. in the liquid from being reduced, and is able to prevent material loss of the pigment etc. from occurring.

### SUMMARY

However, the technology disclosed in JP-A No. 2008-100197 is technology that is effective when taking out a paste when mixing and kneading of a material has finished. Moreover, although the technology disclosed in JP-A No. H7-328407 is technology in which material adhered to the lid and tank inner walls is washed off, the technology relies on a mechanism to spray liquid inside the mixing tank, is only applicable to liquids having a low viscosity, and needs to consider sprayed liquid adhering to the inside of the mixing tank. Hitherto, there is no known mixing tank or mixing device that, at the stage of mixing materials, is capable of simply and reliably returning a material adhered to an inner wall of a mixing tank to material to be subjected to mixing.

In consideration of the above circumstances, an object of the present disclosure is to provide a mixing tank and a mixing device that are capable of simply and reliably returning material adhered to an inner wall to material to be subjected to mixing.

The present disclosure achieves the above object and encompasses the following.
<1> A mixing tank, wherein an upper part of an inner wall in a height direction has a higher surface roughness than a lower part thereof.
<2> The mixing tank of <1>, wherein a region in which the surface roughness is higher is located higher than 50% of a height of the inner wall.
<3> The mixing tank of <1>, wherein indentations and protrusions are provided on the inner wall in a region in which the surface roughness is higher.
<4> The mixing tank of <3>, wherein an inter-protrusion length of the indentations and protrusions is from 0.1 μm to 15 μm.
<5> A mixing device, comprising:
   the mixing tank of any one of <1> to <4>;
   a stirring blade disposed at a tank interior of the mixing tank; and
   a drive device that drives the stirring blade.
<6> The mixing device of <5>, wherein an upper limit of introduced material is a height position at which a surface roughness becomes higher on the inner wall of the mixing tank.

The present disclosure provides a mixing tank and a mixing device that are capable of simply and reliably returning material adhered to an inner wall to material to be subjected to mixing.

### BRIEF DESCRIPTION OF THE DRAWINGS

Exemplary embodiments of the present disclosure will be described in detail based on the following figures, wherein:

FIG. 1 is a schematic configuration diagram schematically illustrating a mixing tank of the present disclosure;

FIG. 2 is a schematic diagram to explain an inter-protrusion length in indentations and protrusions formed to an inner wall of a mixing tank; and

FIG. 3 is a schematic configuration diagram schematically illustrating a mixing device of the present disclosure.

### DETAILED DESCRIPTION

Description follows regarding exemplary embodiments of the present disclosure. The description merely illustrates examples of exemplary embodiments, and does not limit the range of the present disclosure.

In the present specification a numerical range denoted using “to” indicates a range that includes the respective numerical values proceeding and following “to” as the minimum value and the maximum value thereof.

For a numerical range with a stepwise denotation in the present specification, an upper limit value or a lower limit value for one numerical range may be replaced with an upper limit value or a lower limit value for another stepwise numerical range. Moreover, in numerical ranges listed in the present specification, an upper limit value or a lower limit value of the numerical range may be replaced with a value indicated in an Example.

In the present specification the term “process” not only includes an isolation of this process, but as long as the intended objective of the process is achieved, the term may also include cases in which another process is unable to be clearly distinguished therefrom.

When an exemplary embodiment is described with reference to the drawings in the present specification, the configuration of the exemplary embodiment is not limited to the configuration illustrated in the drawings. Moreover, the size of members in the drawings is merely schematic, and relative relationships between the sizes of members is not limited thereto.

### Mixing Tank

In a mixing tank of the present disclosure, an upper part of an inner wall in a height direction has a higher surface roughness than a lower part thereof. The mixing tank of the present disclosure is configured with a surface roughness of an upper section above a specific position in the height direction that is comparatively higher than at a lower section below this position. In the mixing tank of the present disclosure, material adhered to an inside wall where the surface roughness is higher is flaked off from the inner wall under its own weight or by slight vibration, and is returned to a mass of material that is being mixed or kneaded below. Using the mixing tank of the present disclosure accordingly enables a troublesome task of detaching material adhered to an inner wall to be avoided, or enables the prevention of a drop in quality or a drop in productivity arising from material adhering to an inner wall. Note that surface roughness has the same definition as so-called “mean width of the primary profile elements: PSm,” “mean width of the roughness profile elements: RSm,” and “mean width of the waviness profile elements: WSm”, and can be defined according to JIS B 0601-2001.

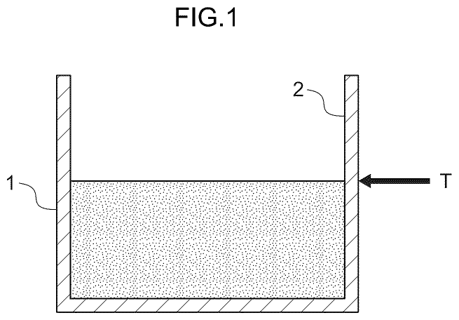

FIG. 1 illustrates an example of a mixing tank of the present disclosure. The mixing tank 1 illustrated in FIG. 1 has a substantially circular cylindrical shape open at an upper face thereof, with a surface roughness of an inner wall 2 of the tank characterized by being higher above a specific position T in the height direction and lower below the position T. There is no particular limitation to the position T, however the position T can be set at a height position of material (solid content, dispersion medium, and other components thereof) introduced into the tank, or a position higher than the height position. Normally material is introduced up to substantially a height direction center (approximately 50% of the height) of the mixing tank 1. Therefore, the specific position T is preferably a position at a height of 50% of the height of the inner wall.

When setting the specific position T at the height position of 50% of the height of the inner wall 2, the same surfaces as, for example, that of an inner wall of a normal mixing tank may be employed below this position T. As an example, the inner wall 2 of the mixing tank 1 below the position T can be configured with a mirrored surface finish. Adopting this approach enables mixing or kneading of material to be performed while imparting a desired sheer between a stirring blade of a mixing device, described later, and the inner wall 2 of the mixing tank 1.

In particular, indentations and protrusions are preferably provided to the inner wall 2 above the position T in the mixing tank 1. Namely, the inner wall 2 of the mixing tank 1 can be configured with a higher surface roughness above position T and a lower surface roughness below position T by forming indentations and protrusions above position T. For example, indentations and protrusions may be provided to the inner wall 2 above position T, and the inner wall 2 below position T may be configured by a mirrored surface. There is no particular limitation to the indentations and protrusions, and reference to indentations and protrusions means a structure in which, when a paste or the like obtained by kneading introduced material has been adhered thereto, a contact surface area is smaller than that of a mirrored surface. Namely, due to the paste etc. contacting the protrusions in the indentations and protrusions formed to the inner wall 2, the paste etc. adhered thereto is more readily detached than when adhered to a mirrored surface.

There is no particular limitation to the indentations and protrusions of the inner wall 2, and examples that can be given thereof include indentations and protrusions formed in at least one profile, or a combination of profiles, selected from the group consisting of dimples that are indented in a spherical shape, embossing that is spherical shaped protrusions, indentations of an indented polygonal cone shape such as a square pyramid shape or the like or circular cone shape, protrusions of a polygonal cone shape such as a square pyramid shape or the like or circular cone shape, indentations of a line shape (straight line shape, curved line shape, zig-zag shape), and protrusions of a line shape (straight line shape, curved line shape, zig-zag shape). Such indentations and protrusions may be formed by, for example, dimple machining, emboss machining, square-pyramid indent machining, square-pyramid protrusion machining, needle machining, knurling (diamond, linear, angled and square knurling), and zig-zag machining etc. These types of machining may be performed using, for example, a precision machining machine such as an ultra-short pulse laser or a computer numerical control (CNC) machining device or a micro-milling machining device.

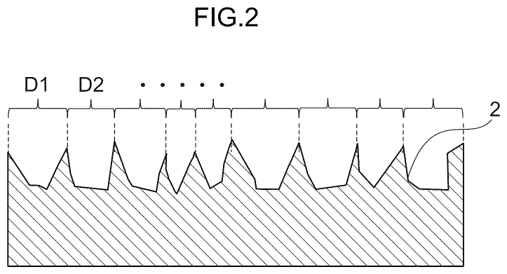

In particular, the indentations and protrusions of the inner wall 2 preferably have an inter-protrusion length of from 0.1 μm to 15 μm. The inter-protrusion length referred to here may, as illustrated in FIG. 2, be a value found by computing a mean distance of distances (D1, D2, . . . in FIG. 2) between adjacent protrusions. The inter-protrusion length in the indentations and protrusions of the inner wall 2 can be measured by analyzing an image captured by a scanning electron microscope of a region including the indentations and protrusions of the inner wall 2. Making the inter-protrusion length of the indentations and protrusions of the inner wall 2 from 0.1 μm to 15 μm enables adhered paste to be easily flaked off from the inner wall under its own weight or by slight vibration.

### Mixing Device

A mixing device of the present disclosure includes the mixing tank described above, a stirring blade disposed at a tank interior of the mixing tank, and a drive device that drives the stirring blade. The mixing device of the present disclosure includes the mixing tank configured as described above, and so material such as a paste adhered to the inner wall in the mixing tank where the surface roughness is higher is flaked off from the inner wall under its own weight or by slight vibration, and is returned to a mass of material that is being mixed or kneaded below. This means that using the mixing device of the present disclosure enables a troublesome task of detaching material adhered to an inner wall to be avoided, or enables prevention of a drop in quality or a drop in productivity arising from material adhering to an inner wall.

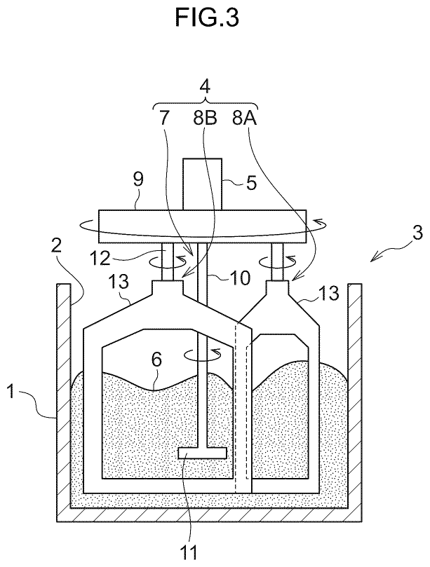

FIG. 3 illustrates an example of a mixing device of the present disclosure. The mixing device 3 illustrated in FIG. 3 includes the mixing tank 1 illustrated in FIG. 1, stirring blades 4 disposed in the tank interior of the mixing tank 1, and a drive device 5 that drives the stirring blades 4. The mixing device 3 illustrated in FIG. 3 is a so-called planetary mixer that is configured to mix and knead a material 6 introduced to the mixing tank 1 by planetary motion of the stirring blades 4. However, the mixing device of the present disclosure is not limited to being a planetary mixer and may be a device with an attached stirring blade having a single rotation shaft, such as a propeller blade, turbine blade, paddle blade, anchor blade, ribbon blade or the like.

The stirring blades 4 in the mixing device 3 comprise a dispersion blade 7, and mixing blades 8A and 8B. The dispersion blade 7 and the mixing blades 8A and 8B are attached to a planetary gear device 9. More specifically, the dispersion blade 7 is attached to a sun gear (not illustrated in the drawings) of the planetary gear device 9, and the mixing blades 8A and 8B are attached to planetary gears (not illustrated in the drawings) of the planetary gear device 9. The dispersion blade 7 includes a first rotation shaft 10, and a blade 11 such as a propeller blade, turbine blade, paddle blade, anchor blade, or ribbon blade attached to a distal end of the first rotation shaft 10. The mixing blades 8A and 8B each include a second rotation shaft 12, and a frame-shaped blade 13 attached to the second rotation shaft 12. The mixing device 3 includes a motor serving as the drive device 5, and rotation force from the motor is transmitted to the first rotation shaft 10 and to the second rotation shaft 12 through the sun gear and the planetary gear of the planetary gear device 9.

Note that the mixing device of the present disclosure may include the mixing tank described above provided so as to be attachable and detachable thereto, and may include the mixing tank fixed thereto. Namely, in the mixing device 3 illustrated in FIG. 3, the mixing tank 1 may either be provided attachable and detachable thereto, or fixed thereto. Moreover, a drive device (not illustrated in the drawings) for positioning the stirring blades 4 in the tank interior of the mixing tank 1 may be provided in the mixing device 3 illustrated in FIG. 3.

Employing the mixing device of the present disclosure configured as described above enables material introduced into the mixing tank to be mixed or kneaded. The material introduced into the mixing tank is not particularly limited, and is preferably a material including solid content and a dispersion medium. The mixing device of the present disclosure enables a target paste to be produced by mixing and kneading a material containing solid content and dispersion medium. In particular, the mixing device of the present disclosure is applicable to stirring a material having a high viscosity. As an example, description follows regarding a process that employs the mixing device 3 illustrated in FIG. 3 to produce a negative electrode paste used in a secondary battery. Note that a positive electrode paste can also be produced similarly to the negative electrode paste. Furthermore, the mixing device 3 can also be applied to producing a paste different to a negative electrode paste or a positive electrode paste and employed in an application other than a secondary battery.

First, a carbon powder that is an active substance (with a D50 of from 5 μm to 30 μm), a carboxymethyl cellulose (CMC) powder that is a dispersant, and a carbon nano tube (CNT) powder that is a conduction enhancer are introduced into the mixing tank 1 as the material 6. The motor of the drive device 5 is driven in a state in which these powders have been introduced into the mixing tank 1, and mixing is performed by the dispersion blade 7 and the mixing blades 8A and 8B in a state of just powders. Next, water is introduced into the mixing tank 1 as a dispersion medium. Note that rather than adding all of the water that should be added to the target negative electrode paste all at once, preferably half the water, for example, is added at this step. The motor of the drive device 5 is then driven in this state, and the dispersion medium and the powders that have been introduced into the mixing tank 1 are kneaded by the dispersion blade 7 and the mixing blades 8A and 8B (a rough kneading process). In this rough kneading process, the viscosity is high until each of the powders that remain in a powder state have been somewhat dispersed, and so preferably, from the perspective of preventing malfunction of the motor of the drive device 5, kneading is performed at a comparatively low rotation speed until dispersion of the powders has progressed and viscosity has settled down.

Next, the rotation speed of the motor is raised and a thick paste process is executed. The thick paste process is performed on the material 6 in which dispersion has somewhat progressed by the above kneading, and dispersion is progressed further while further knocking the powders against each other to eliminating powder lumps. Then when the thick paste process has finished, the remaining dispersion medium is introduced into the mixing tank 1, and kneading is continued while maintaining the rotation speed used during the thick paste process. After this a styrene-butadiene rubber or the like is added to the mixing tank 1 as a binder, and while maintaining the rotation speed and continuing kneading, kneading is continued until the added binder has been uniformly dispersed, finally completing the negative electrode paste having a viscosity of, for example, from 5000 Pa·s to 500,000 Pa·s (shear speed: 0.1 s⁻¹).

As described above, the mixing device 3 enables a target negative electrode paste to be produced. When doing so, the material 6 mixed and kneaded by the stirring blades 4 gradually changes into a paste form, however sometimes material adheres to the inner wall 2 as it is being mixed. However, due to having a higher surface roughness on the inner wall 2 of the mixing tank 1 above the position T, the adhered material 6 is flaked off from the inner wall under its own weight or by slight vibration and returned to the mass of the material 6 that is being mixed and kneaded below. This means that the mixing device 3 does not generate a troublesome task of detaching material 6 adhered to the inner wall 2, or is able to prevent a drop in quality or a drop in productivity arising from the material 6 adhering to the inner wall 2.

Moreover, in particular in the mixing device 3, an upper limit of introduced material is preferably the height position T where the surface roughness of the inner wall 2 of the mixing tank 1 becomes higher. For an example of producing the negative electrode paste as described above, at the last stage when the binder is introduced all of the material 6 inside the mixing tank 1 is at a height of the height position T or lower where the surface roughness of the inner wall 2 of the mixing tank 1 becomes higher. Note that the height of the material 6 introduced to the mixing tank 1 is measured in a state not being stirred. By making the height of the material 6 introduced to the mixing tank 1 below the position T where the surface roughness of the inner wall 2 becomes higher, an appropriate sheer can be imparted by the stirring blades 4 to the material 6.

What is claimed is:

1. A mixing tank, wherein an upper part of an inner wall in a height direction has a higher surface roughness than a lower part thereof.

2. The mixing tank of claim 1, wherein a region in which the surface roughness is higher is located higher than 50% of a height of the inner wall.

3. The mixing tank of claim 1, wherein indentations and protrusions are provided on the inner wall in a region in which the surface roughness is higher.

4. The mixing tank of claim 3, wherein an inter-protrusion length of the indentations and protrusions is from 0.1 μm to 15 μm.

5. A mixing device, comprising:
the mixing tank of any one of claim 1;
a stirring blade disposed at a tank interior of the mixing tank; and
a drive device that drives the stirring blade.

6. The mixing device of claim 5, wherein an upper limit of introduced material is a height position at which a surface roughness becomes higher on the inner wall of the mixing tank.
